(19) United States
(12) Patent Application Publication
(10) Pub. No.: US 2011/0113342 A1
(43) Pub. Date: May 12, 2011

(54) SYSTEM AND METHOD FOR BROADCASTING, SHOWCASING AND INTERACTING WITH MULTMEDIA PORTFOLIOS

(76) Inventor: Jose Ariel Gomez Ortigoza, Oakland, CA (US)

(21) Appl. No.: 12/823,413

(22) Filed: Jun. 25, 2010

Related U.S. Application Data
(60) Provisional application No. 61/220,362, filed on Jun. 25, 2009.

(51) Int. Cl. G06F 3/048; G06F 15/16

(52) U.S. Cl. 715/738; 709/217

(57) ABSTRACT

A system for broadcasting, showcasing and interacting with a plurality of multimedia portfolios on at least one electronic multimedia platform to indicate an encapsulated representation of an identity of at least one entity is disclosed. The system comprises at least one electronic portfolio viewing provider and at least one electronic multimedia platform. The system further includes at least one electronic communication device and at least one electronic communication network operable to interconnect the at least one electronic portfolio viewing provider, the at least one electronic communication device, and the at least one electronic multimedia platform. The identity of the at least one entity is delivered as an interactive multimedia portfolio to showcase the skills, aesthetics, content or information related to the at least one entity.

### CROSS-REFERENCE TO RELATED APPLICATION

This application claims the benefit of the priority date of provisional application No. 61/220,362, filed on Jun. 25, 2009.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates generally to the field of electronic media, and more particularly to a system for broadcasting, showcasing and interacting with multimedia portfolios on an electronic media platform for indicating an encapsulated representation of the identity of an entity.

The implementation of multimedia portfolio management systems has eased time management to showcase the skills, aesthetics, content or information related to a user by way of an electronic media platform. In today's busy schedule, a person having basic knowledge in using a computer can create professional-grade portfolios within hours. There is a need for a user-friendly multimedia portfolio management system for broadcasting, showcasing and interacting with multimedia portfolios on an electronic media platform. Several types of multimedia portfolio management systems have been developed in the art for presenting the information related to a user.

U.S. Pat. Application No. 20080086678 in the name of Herzman describes a system and method for creating, displaying and searching for a multimedia presentation over a communication network. Multimedia presentation modules are stored on an information processor that enables users to select options associated with the multimedia presentation. Further, an internet website is hosted on the information processor, and the internet web site includes restricted and unrestricted access for users. A user defines a multimedia presentation by selecting a template provided by an information processor. The user further defines at least image and text components to be included in the multimedia presentation by selecting from the information processor or uploading to the information processor the image and/or textual components. The information processor generates and stores the multimedia presentation. A message is then transmitted to a recipient enabling the recipient to access the multimedia presentation using at least one of a web browser software application, an e-mail software application or a cellular telephone. Further, an interface is provided on the information processor enabling the user or other users to search for, locate and view the multimedia presentation.

U.S. Pat. Application No. 20050240909 in the name of Tersigni describes a method and system for displaying a multimedia portfolio. The method includes the steps of establishing a multimedia portfolio with an identifier; preparing a multimedia content associated with a predetermined topic; selecting a predetermined template for the display of the multimedia content; compiling the multimedia content based on the predetermined template; and displaying the multimedia portfolio. The system includes a processor; a user interface functioning via the processor; a repository accessible by the processor; and a receiving means for receiving data for the processor. The processor, based on the data received from the receiving means, establishes a multimedia portfolio with an identifier; prepares a multimedia content associated with a predetermined topic; and displays the multimedia portfolio.

U.S. Pat. No. 5,999,915 issued to Nahan describes a system and method of electronically executing transactions with a pre-programmed main computer having data and image storage and retrieval equipment. A plurality of electronic images of works of art that are for sale are created by at least one listing dealer and stored on the storage equipment associated with the main computer. Data is input about each stored image and input data is associated with each corresponding stored image. Search criteria are input through intelligent terminals for selecting at least one of the stored electronic images for review. Selected images and corresponding data are communicated to the intelligent terminals and at least a portion of the selected electronic images are displayed. A reservation on at least one of the displayed electronic images can be made to prevent the completion of a sales transaction involving the artwork corresponding to the selected, reserved electronic image. An indication of the reserve status of the work is displayed in conjunction with the display of the reserved work on any of the intelligent terminals. A buy order can be input on the intelligent terminals to transact a purchase of the artwork corresponding to the electronic image subject to the buy order. Instructions to complete the purchase are automatically generated and communicated to the intelligent terminals corresponding to the appropriate listing dealer and the appropriate buying dealer.

Most of these systems for interacting with multimedia portfolios described herein are complex and not user-friendly. Some require extensive computer programming and code writing experience. Some of these systems cannot be accessed from a remote location and are not compatible with present day electronic devices and electronic communication systems. Moreover, some of these systems are not configurable to showcase an encapsulated representation of the skills, aesthetics, content or information related to a user by way of an electronic media platform.

It is therefore, an object of the present invention to provide a simple, flexible and user-friendly system for broadcasting, showcasing and interacting with multimedia portfolios on an electronic media platform. Another object of the present invention is to provide a system that can be accessed from a remote location and are compatible with the present day electronic devices and electronic communication systems. Yet another object of the present invention is to provide a system that can showcase an encapsulated representation of the skills, aesthetics, content or information related to a user. Other objects of the present invention will become better understood with reference to appended Summary, Description and Claims.

Some examples of intended use for this invention are as follows: (1) PERFORMING ARTS/CELEBRITIES. Delivery of the identity of an artist or artistic group by combining their background and career information with the digital content of their live performances through photos, audio and video. In this way the viewer will combine Bio and Portfolio information of the artistic entity with a multimedia representation to showcase their artistic talent in an entertaining way that can be broadcasted into any electronic media platform for delivery; (2) SPORTS. Delivery of the identity of an athlete or a sports team by combining their background and sports career information with the digital content of their games and competitions through photos, audio and video. In this way the viewer will combine Bio and Portfolio information of the athletic entity with a multimedia representation to showcase their talent in an entertaining way that can be broadcasted into any electronic media platform for delivery; (4) MODELING. Delivery of the identity of a fashion model or designer company by combining their background and career information with the digital content of their fashion shows through photos, audio and video. In this way the viewer will combine Bio and Modeling information of the model or design entity with a multimedia representation to showcase their talent in an entertaining way that can be broadcasted into any electronic media platform for delivery; (5) PUBLIC FIGURES. Delivery of the identity of a public figure, political candidate, speaker, superstar or any other rich and famous person by combining their background and life information with the digital content of their activities through photos, audio and video. In this way the viewer will combine Bio and real life information of the person or entity with a multimedia representation to showcase their qualities, life and experience in a structured and entertaining way that can be broadcasted into any electronic media platform for delivery; (6) SPECIALIZED PROFESSIONALS AND TECHNICIANS. Delivery of the identity of any type of professional or technician skilled in any specific art, ability or science by combining their background and skill information with the digital content of their activities through photos, audio and video. In this way the viewer will combine Bio and skill information of the person or entity with a multimedia representation to showcase their skill, abilities and experience in a structured and entertaining way that can be broadcasted into any electronic media platform for delivery; (7) MOVIES, MUSIC ALBUMS, PLAYS, CONCERTS, TV PROGRAMMING, LECTURES, SPEECHES, ARIAS OR SOAP OPERAS. Delivery for promotional purposes of an encapsulated object containing the identity of any type of representation, performance, entity or product by showcasing a combination of the representation, performance, entity or product with further content and information related to the process of its creation, production, people involved, audience engagement, feedback and statistics in a structured and entertaining way that can be broadcasted into any electronic media platform for delivery. (8) ADVERTISING. Delivery for advertising or commercial purposes of an encapsulated object containing the identity of a commercial product or group of commercial products by showcasing a combination of multimedia content and information related to its background information, characteristics, production process, related events, related games, points of sale, related people or characters, related audience, feedback and statistics in a structured, interactive and entertaining way that can be broadcasted into any electronic media platform for delivery. (9) TOURS. Delivery for advertising or commercial purposes of an encapsulated object containing the identity of a place, city or country by showcasing a combination of multimedia content and information related to its background information and sites. (10) PRODUCTS AND SERVICES. Delivery for advertising or commercial purposes of an encapsulated object containing the identity of a commercial product or service by showcasing a combination of multimedia content and information related to its specifications and characteristics.

### SUMMARY

The present invention is a system for broadcasting, showcasing and interacting with a plurality of multimedia portfolios on at least one electronic multimedia platform to indicate an encapsulated representation of an identity of at least one entity. The system comprises at least one electronic portfolio viewing provider and at least one electronic multimedia platform. The system further includes at least one electronic communication device and at least one electronic communication network operable to interconnect the at least one electronic portfolio generating and viewing provider, the at least one electronic communication device, and the at least one electronic multimedia platform. The identity of the at least one entity is delivered as an interactive multimedia portfolio to showcase the skills, aesthetics, content or information related to the at least one entity.

The at least one entity may include a single person, a group of people, a company, an ethnic group, a single product/service, a group of products/services or an audio visual production. The at least one electronic communication device may include desktop computers, laptop computers, personal digital assistants (PDA), televisions (TV), portable audio players, cellular phones, game consoles, set top boxes, Internet protocol televisions (IPTV), electronic book readers and electronic tablets. The at least one electronic communication network may be a wired network, wireless network, Internet and an intranet, and the like. The multimedia contents may be a video data, an audio data, a photograph, a written document and the like. The at least one electronic multimedia platform may be a website, web service, or a software application.

The electronic portfolio viewing provider may include the generation and publishing engine. The user can interact with the electronic portfolio viewing provider by way of the generation and publishing engine. The generation and publishing engine is configured to receive data, multimedia files and software applications about an entity. The generation and publishing engine may compile a dynamic hierarchy of contents about a particular portfolio and for display. The electronic portfolio viewing provider may further include a broadcast and interactions engine. The viewing user can interact with an electronic portfolio viewing provider by way of the broadcast and interactions engine.

The broadcast and interactions engine responds to requests about a particular portfolio of the multimedia portfolio broadcasting, viewing and interacting system by displaying the portfolio to the user by way of an electronic multimedia platform described herein, over an electronic communication network. The contents of the multimedia portfolios may be stored in a portfolio database. The electronic portfolio viewing provider may include at least one application loader. Software applications stored in the portfolio database may be loaded for execution by the broadcast and interaction engine using the application loader.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE DRAWINGS

FIG. 1 is a diagrammatic illustration of the present invention, showing a system for broadcasting, showcasing and interacting with a plurality of multimedia portfolios on at least one electronic media platform.

FIG. 2 is a schematic diagram of the present invention, illustrating an electronic portfolio generating and viewing provider.

FIG. 3 is a process flow diagram of the present invention, illustrating an electronic portfolio generation and publishing engine.

FIG. 4 is a process flow diagram of the present invention, illustrating an electronic portfolio broadcast and interaction engine.

FIG. 5 is an operational flowchart of the present invention, illustrating a method for broadcasting, showcasing and interacting with a plurality of multimedia portfolios on an electronic media platform.

FIG. 6 is a screenshot of a webpage of the present invention, illustrating a web service/application for interacting with the plurality of multimedia portfolios.

### REFERENCE NUMERALS

10 . . . A system for broadcasting, showcasing and interacting with a plurality of multimedia portfolios
30 . . . At least one electronic portfolio viewing provider
32 . . . Electronic Portfolio Generation and publishing engine
34 . . . Electronic Portfolio Broadcast and interaction engine
36 . . . Portfolio database
38 . . . Application loader
40 . . . At least one electronic multimedia platform
50 . . . At least one electronic communication device
60 . . . At least one electronic communication network
72 . . . At least one user access system with a communication device
74 . . . Identify a subject entity
76 . . . Assign a hierarchy
78 . . . Content and information
80 . . . Transfer related data, resource and/or digital content
82 . . . Retrieve related data, resources and/or digital content
84 . . . Automatically assemble subject entity's portfolio
86 . . . Publish for delivery
88 . . . Send encapsulated object to delivery platform
90 . . . Embed encapsulated object on delivery platform
102 . . . Viewer access system with a communication device
104 . . . Access multimedia portfolio within electronic platform
106 . . . Select a section of hierarchy
108 . . . Navigation
110 . . . Play multimedia content and information
112 . . . Engage in actions
114 . . . Select a subsection of hierarchy
116 . . . Move to any section of hierarchy
118 . . . Return to any location within electronic platform
120 . . . A method for broadcasting, showcasing and interacting with a plurality of multimedia portfolios
122 . . . Generate electronic portfolio for an entity
124 . . . Publish electronic portfolio
126 . . . Deliver portfolio to electronic platform
128 . . . Broadcast portfolio on electronic platform
130 . . . Interactivity
140 . . . A web service/application for entering applicable information for broadcasting, showcasing and interacting with a plurality of multimedia portfolios

### DETAILED DESCRIPTION

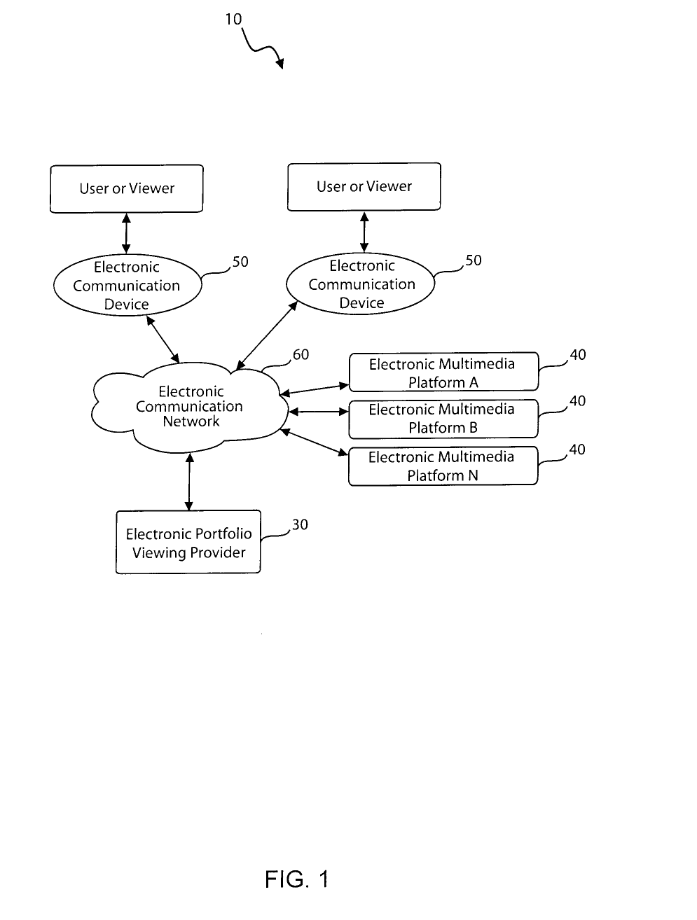

Referring to FIGS. 1 through 6, a preferred embodiment illustrates a system for broadcasting, showcasing and interacting with a plurality of multimedia portfolios 10 on at least one electronic multimedia platform 40 to indicate an encapsulated representation of an identity of at least one entity. Referring to FIG. 1, the system 10 comprises at least one generation and publishing engine 32 and/or one broadcast and interaction engine 34 coupled with at least one electronic portfolio viewing provider 30 by way of the at least one electronic multimedia platform 40. The system 10 further includes at least one electronic communication device 50 and at least one electronic communication network 60 operable to interconnect the at least one electronic portfolio viewing provider 30, the at least one electronic communication device 50, and the at least one electronic multimedia platform 40. The identity of the at least one entity is delivered as an interactive multimedia portfolio to showcase the skills, aesthetics, content or information related to the at least one entity.

With reference to FIG. 1, the entity may include a single person, a group of people, a company, an ethnic group, a single product/service, a group of products/services or an audio visual production. The at least one electronic communication device 50 may include desktop computers, laptop computers, personal digital assistants (PDA), televisions (TV), portable audio players, cellular phones, game consoles, set top boxes, Internet protocol televisions (IPTV), electronic book readers and electronic tablets. The at least one electronic communication network 60 may be a wired network, wireless network, Internet, Intranet, and the like. The multimedia contents may be a video data (See FIGS. 12, 12a, 12b), an audio data (see FIGS. 12, 12a, 12b), a photograph, a written document and the like. The at least one electronic multimedia platform 40 may be a website, web service, or a software application. The Electronic Portfolio Viewing Provider 30 may be SOFTWARE that comprises a generation and publishing engine 32 and a broadcast and interaction engine 34. The generation and publishing engine 32 may be software for designing a portfolio of an entity and is configured to browse local or remote media platforms such as the local computer used by the user, the Internet, Intranet, a social networking platform, online stores, a PDA, a portable music device, a cellular phone, a game console or TV networks, in order to obtain references to multimedia content and information related to the subject entity within other media platforms and aggregate that content to its existing multimedia content and information automatically. The broadcast and interaction engine 34 may be software that allows a viewer or user to interact with the electronic portfolio viewing provider and responds to requests about a particular portfolio by displaying the portfolio to the user by way of an electronic multimedia platform over an electronic communication network.

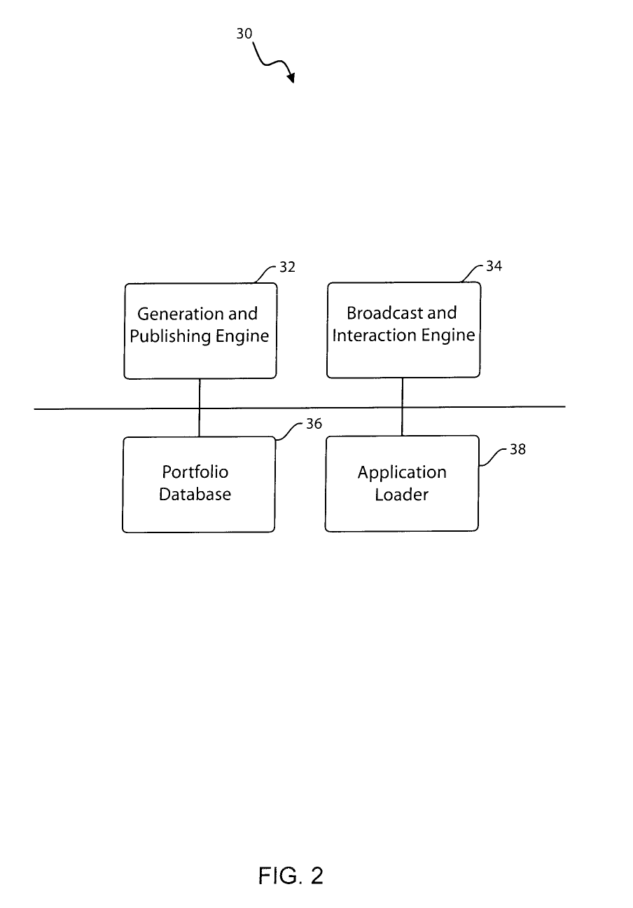

FIG. 2. illustrates a schematic diagram of an electronic portfolio viewing provider 30 of the present invention. The electronic portfolio viewing provider includes at least one service provider that provides portfolio generation, viewing, broadcasting and/or interactive services over the electronic multimedia platform 40. A portfolio database 36 is provided for storing multimedia portfolios associated with each entity. When a user requests the service provided by the electronic portfolio viewing provider 30, an electronic multimedia portfolio may be generated for a subject entity. The portfolio database 36 is provided for storing data, multimedia content and/or software applications related to the subject entity. The contents of the multimedia portfolios may be stored in the portfolio database 36.

When the user adds additional data to the electronic multimedia portfolio, such as adding additional background information, the electronic multimedia portfolio in the portfolio database 36 may be updated with the data added. The multimedia portfolio may be stored, modified, added to any storage medium. The multimedia portfolio may be created outside of the electronic portfolio broadcasting, showcasing and interacting environment and provided to, or accessed by, the electronic portfolio viewing provider 30. Alternatively, the portfolio database 36 may be located remotely and accessed by the at least one electronic portfolio viewing provider.

The electronic portfolio viewing provider 30 may include the generation and publishing engine 32. The user can interact with the electronic portfolio viewing provider 30 by way of the generation and publishing engine 32. The generation and publishing engine 32 is configured to receive data, multimedia files and software applications about at least one entity. The generation and publishing engine 32 may compile a dynamic hierarchy of contents about a particular portfolio and for display. The generation and publishing engine 32 may send or transfer the portfolio to the electronic multimedia platform 40 by way of the electronic communications network 60. The electronic portfolio viewing provider 30 may further include a broadcast and interactions engine 34. The viewer or user can interact with the electronic portfolio viewing provider 30 by way of the broadcast and interactions engine 34.

The broadcast and interactions engine 34 responds to requests about a particular portfolio of the multimedia portfolio broadcasting, viewing and interacting system by displaying the portfolio to the user by way of the electronic multimedia platform 40 described herein, over an electronic communication network 60. The electronic portfolio viewing provider 30 may further include at least one application loader 38 for loading applications related to the portfolio. Software applications stored in the portfolio database 36 may be loaded for execution by the broadcast and interaction engine 34 by using the application loader 38.

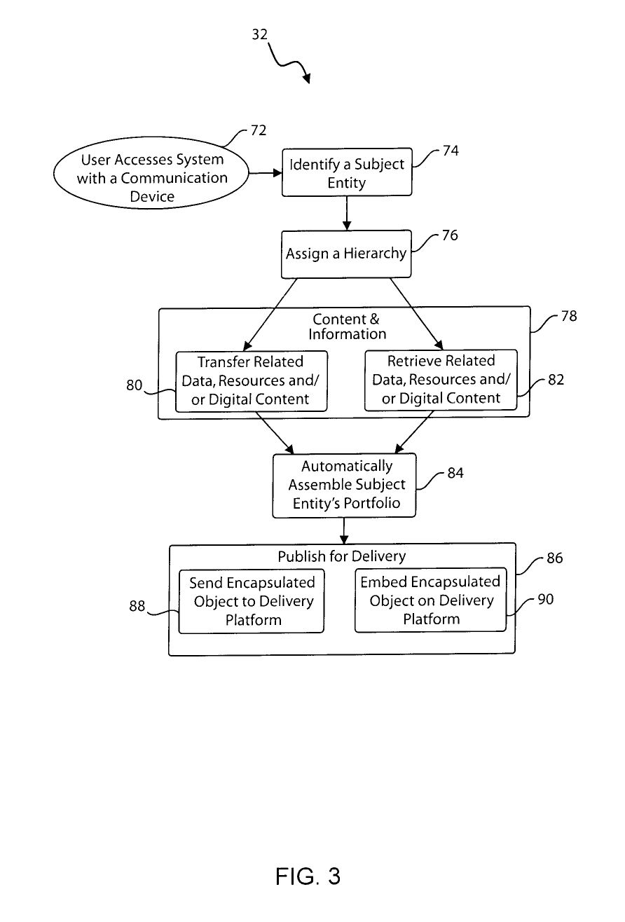

FIG. 3 illustrates a process flow diagram of the electronic portfolio generation and publishing engine 32 to utilize data, multimedia files and software applications related to the subject entity to assemble a list of one or more items of multimedia content, software applications, or any other content for display to a viewing user. In FIG. 3, a user utilizes at least one user access system with a communication device 72 to access electronic portfolio generation and publishing engine 32 by way of an electronic communication network 60. The electronic portfolio generation and publishing engine 32 may comprise software for creating a portfolio, an application service provider for creating a portfolio, or any other device or application capable of providing portfolio generation and publishing services over the electronic multimedia platform 40. At step 74, the user provides data items identifying the subject entity within the electronic portfolio generation and publishing engine 32.

At step 76, a hierarchy corresponding to the electronic portfolio's content is defined by the electronic portfolio generation and publishing engine 32. The classification may be defined based on the category of the subject entity. The user may instruct the electronic portfolio generation and publishing engine 32 to modify the classification and structure of the assigned hierarchy in a preferred way. At step 78, the data and/or content of the electronic portfolio are provided by the user. As discussed herein, the data and/or contents of the electronic portfolio may comprise digital data, digital media content, software applications or any other kind of data or digital media.

At step 80, the user may transfer one or more pieces of data and/or content for the multimedia portfolio over an electronic communication network 60 by using a user access system with a communication device 72. The user may enter data into form(s) (See FIGS. 7-13) and send the form(s) to the electronic portfolio generation and publishing engine 32. At step 82, the user may identify where one or more pieces of data and/or content for the multimedia portfolio are available for retrieval by way of the electronic communication network 60 (See FIG. 8). The electronic portfolio generation and publishing engine 32 may then retrieve the one or more pieces of data and/or resources and transfer them back to the electronic portfolio generation and publishing engine 32.

In one instance, a user may submit one or more software applications in different ways. The user may provide the code for the software application. The user may provide a call to an external electronic platform by using an application-programming interface (API). The user may identify where one or more pieces of code are available for retrieval by way of the electronic communication network 60. The transferred data, content and/or software applications are stored in at least one database (not shown) by the electronic portfolio generation and publishing engine 32 to be available for execution. The multimedia portfolio may be updated by adding sections and/or section items about new content available and/or removing section items about previous content. At step 84, the data, content and/or software applications are retrieved from the database (not shown). A virtual object is dynamically assembled in an automated way by structuring the contents of the multimedia portfolio in relation to the defined hierarchy. This generates a self-contained delivery package (“virtual object”) that can be sent across the electronic communications platform 60. This virtual object may comprise a hierarchy of contents. The hierarchy of contents may comprise one or more multimedia files such as video data, audio data, one or more photographs, or one or more pieces of written information such as biographies, lectures and specifications, virtual goods or services, one or more advertisements, one or more interactive software applications, or a combination of these.

At step 88, the electronic portfolio generation and publishing engine 32 may send the virtual object to the electronic multimedia platform 40 by way of the electronic communication network 60 to be ready for viewing. In another embodiment, the multimedia portfolio as a virtual object may be sent to a website/software application by sending the website/software application an API request that contains an instruction to load the portfolio from the multimedia portfolio generating and viewing provider. The multimedia portfolio may be sent to an online marketplace by transferring the self-contained package to the online marketplace by way of the electronic communication network 32. At step 90, an access point for viewing the portfolio may be embedded within the electronic multimedia platform 40 by way of the electronic communication network 60. A link may be placed within an online marketplace or within an advertising banner to provide an access point to the multimedia portfolio.

The multimedia portfolios may be transferred to the user access system with an electronic communication device 72 to provide a local access point to the multimedia portfolios. This access point would load the multimedia portfolio from a local storage medium for display or load it by way of the at least one electronic communication network 60 from an external memory system. At this point, the user, may access the multimedia portfolio by way of the broadcast and interaction engine 34. The user may also provide the applications that may be included as part of the portfolio that may be integrated into the Application Loader 38.

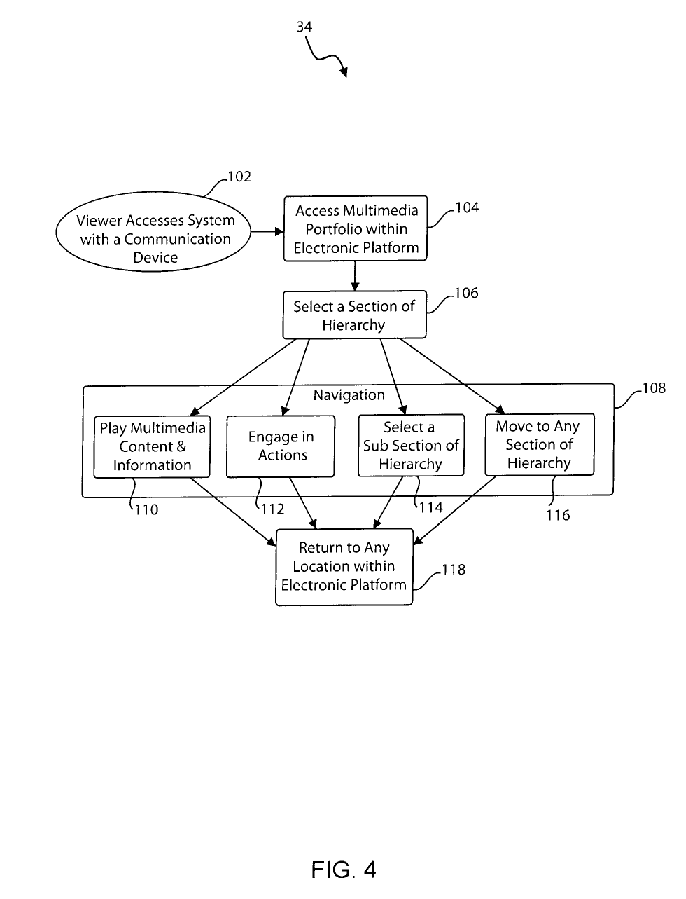

In FIG. 4, the electronic portfolio broadcast and Interaction engine 34 may be accessed by the user by way of an electronic platform 40 such as shown in step 104. In step 106, the viewing user may choose to select any section of the portfolio being viewed and navigate to it or showcase it. In step 110, the user may play the data, multimedia files and/or software applications inside the chosen section. The user 1 may be able to navigate a map, post a message about the multimedia portfolio, hire a service related to the portfolio's subject entity. In step 114, the user may choose to select any subsection of the current section and navigate to it or showcase it. In step 116, the user may choose to select any other section of the portfolio and navigate to it or showcase it.

The user may be able to navigate the multimedia portfolio by interacting with it, accessing the different sections and/or items and moving back and forward at will. In step 118, the user may choose to “close” the multimedia portfolio environment and return to any location within the electronic platform 40 where the viewing user accessed the at least one broadcasting and interaction engine 34. The user may choose to return to the location where the multimedia portfolio was first accessed within the electronic platform 40.

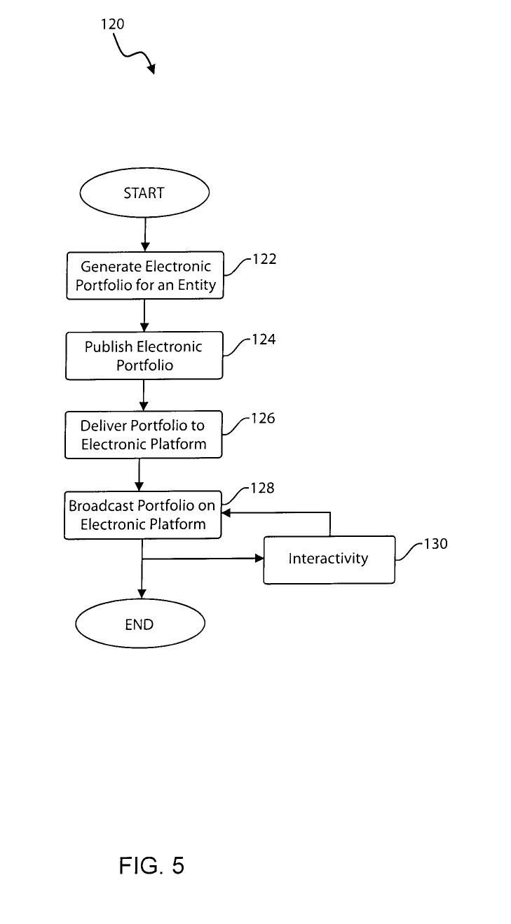

FIG. 5 shows an operational flowchart of a method 120 for broadcasting, showcasing and interacting with a plurality of multimedia portfolios on an electronic multimedia platform 40. The method 120 is initiated in block 122, the user generates a multimedia portfolio for the subject entity by way of the electronic portfolio viewing provider 30. In block 124, the user publishes the assembled multimedia portfolios to the electronic multimedia platform 40 by way of the electronic communications network 60. In block 126, a user requests a portfolio by way of an electronic multimedia platform 40. The electronic portfolio viewing provider 30 receives the request and delivers the multimedia portfolio as a virtual object to the user by way of the electronic communications network 60. In block 128, the multimedia portfolio is received by the electronic multimedia platform 40 and the user views and broadcasts a section or item of the portfolio, such as a complete section, a piece of data, a multimedia file and/or run a software application. In block 130, the viewing user may continue to broadcast other sections or items of the portfolio by requesting those sections and/or items.

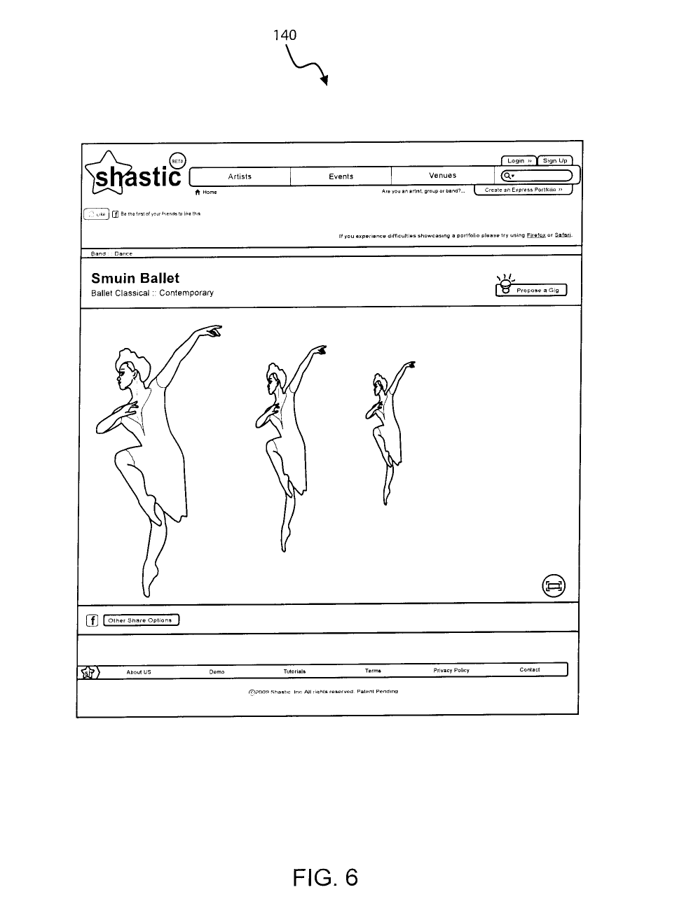

FIG. 6 is a screenshot illustrating a web service/application 140 for entering applicable information for broadcasting, showcasing and interacting with a plurality of multimedia portfolios on at least one electronic multimedia platform 40 to indicate an encapsulated representation of an identity of at least one entity. The web service/application 140 shows the portfolios of the subject entity. The at least one entity may include, a single person (e.g., artists), a group of people, a company, an ethnic group, a single product/service, a group of products/services or an audio visual production.

FIG. 7-13 show different embodiments of forms sent to the electronic portfolio generation and publishing engine 32.

FIG. 7 asks for basic information about the user, which may or may not be the same as the subject entity to be viewed through an electronic multimedia platform 40. It requires that a user create an account to utilize the system.

FIG. 8 illustrates how a user may make one or more pieces of data and/or content for the multimedia portfolio available for retrieval by way of the electronic communication network 60. For example, a user can utilize the invention to publish a resume, making his or her portfolio, career status, prior employment, education, work samples, etc, publicly available. The invention may also be utilized to publish information about a product/service.

FIG. 9 shows how a user can create an identity for himself by creating an account for example as a single artist who is actively performing in the field of music and electronics. In other instances it can create an identity for a product/service.

FIG. 10 shows how users can create a personal or product/service statement to attract users to his portfolio.

FIG. 11 shows how a user can create a biography or specification for the subject entity. In FIG. 11, the biography is that of the user.

FIGS. 12, 12a, and 12b illustrate how a user can upload photos, audio files, and video files to the multimedia portfolio.

FIG. 13 illustrates how a user can create a repertoire of music, data, video or audio files of his work as part of the multimedia portfolio.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A system for broadcasting, showcasing and interacting with a plurality of multimedia portfolios on at least one electronic multimedia platform to indicate an encapsulated representation of an identity of at least one entity, the system comprising:
at least one electronic portfolio viewing provider;
at least one electronic communication device; and
at least one electronic communication network operable to interconnect the at least one electronic portfolio viewing provider, the at least one electronic communication device, and the at least one electronic multimedia platform;
whereby the identity of the at least one entity is delivered as an interactive multimedia portfolio to showcase the skills, aesthetics, content or information related to the at least one entity.

2. The system of claim 1, wherein the at least one entity is a single person, a group of people, a company, an ethnic group, a product or service, a group of products or services, or an audio visual production.

3. The system of claim 1, wherein the at least one electronic portfolio viewing provider comprises at least one electronic portfolio generation and publishing engine.

4. The system of claim 3, wherein the at least one electronic portfolio generation and publishing engine is software for creating a portfolio of an entity or an application service provider for creating a portfolio of an entity.

5. The system of claim 3, wherein the electronic portfolio generation and publishing engine is configured to browse local or remote media platforms, including the local computer used by a user, the Internet, an Intranet, a social networking platform, online stores, a PDA, a portable music device, a cellular phone, a game console or TV networks, in order to obtain references to multimedia content and information related to the subject entity within other media platforms and aggregate that content to its existing multimedia content and information automatically.

6. The system of claim 1, wherein the at least one electronic portfolio viewing provider comprises at least one electronic portfolio broadcast and interaction engine.

7. The system of claim 6, wherein the at least one electronic portfolio broadcast and interaction engine is software that allows a viewer or user to interact with the electronic portfolio viewing provider and responds to requests about a particular portfolio by displaying the portfolio to the user by way of an electronic multimedia platform over an electronic communication network.

8. The system of claim 1, wherein the at least one electronic portfolio viewing provider comprises at least one portfolio database.

9. The system of claim 1, wherein the at least one electronic portfolio viewing provider comprises at least one application loader for loading software applications stored in the at least one portfolio database.

10. The system of claim 1, wherein the at least one electronic communication device includes desktop computers, laptop computers, personal digital assistants (PDA), televisions (TV), portable audio players, cellular phones, game consoles, set top boxes, Internet protocol televisions (IPTV), electronic book readers and electronic tablets.

11. The system of claim 1, wherein the at least one electronic multimedia platform is a website, a web service, or software application.

12. The system of claim 1, wherein the plurality of multimedia portfolios are configured to embed in the at least one electronic multimedia platform.

13. The system of claim 1, wherein the plurality of multimedia portfolios are configured to be accessed by way of the at least one electronic communication device.

14. The system of claim 1, wherein the plurality of multimedia portfolios are stored locally or remotely in the at least one internal or external memory system.

15. The system of claim 1, wherein the encapsulated representation is a virtual object containing a hierarchy of contents; the hierarchy of contents comprising one or more multimedia files such as video data, audio data, one or more photographs, or one or more pieces of written information such as biographies, lectures and specifications, virtual goods or services, one or more advertisements, or one or more interactive software applications.

16. A method for generating and publishing at least one multimedia portfolio on at least one multimedia platform to indicate an encapsulated representation of an identity of at least one entity, the method comprising:
accessing a system with a communication device;
identifying a subject entity;
assigning a hierarchy;
transferring or receiving data, including multimedia resources and digital content into an electronic portfolio generation and publishing engine;
assembling a portfolio of the at least one entity; and
sending or embedding an encapsulated virtual object to a delivery platform.

17. The method of claim 16, wherein the encapsulated representation is a virtual object containing a hierarchy of contents; the hierarchy of contents comprising one or more multimedia files such as video data, audio data, one or more photographs, or one or more pieces of written information such as biographies, lectures and specifications, virtual goods or services, one or more advertisements, or one or more interactive software applications, wherein the at least one entity is a single person, a group of people, a company, an ethnic group, a product or service, a group of products or services, or an audio visual production.

18. The method of claim 16, wherein the at least one entity is a single person, a group of people, a company, an ethnic group, a product or service, a group of products or services, or an audio visual production.

19. A method of broadcasting, showcasing, and interacting with at least one multimedia portfolio on at least one multimedia electronic platform to indicate an encapsulated representation of an identity of at least one entity, the method comprising the steps of:
requesting the at least one multimedia portfolio by way of the at least one electronic multimedia platform;
receiving the request for the at least one multimedia portfolio by utilizing at least one electronic portfolio viewing provider;
compiling a dynamic hierarchy of contents about the at least one multimedia portfolio for display;
delivering the at least one multimedia portfolio as a virtual object to a user by way of an electronic communication network;
receiving the at least one multimedia portfolio and viewing or broadcasting the contents of the at least one multimedia portfolio on the at least one electronic multimedia platform; and
interacting with the contents of the at least one portfolio.

20. The method of claim 19, wherein the encapsulated representation is a virtual object containing a hierarchy of contents; the hierarchy of contents comprising one or more multimedia files such as video data, audio data, one or more photographs, or one or more pieces of written information such as biographies, lectures and specifications, virtual goods or services, one or more advertisements, or one or more interactive software applications.

21. The method of claim 19, wherein the at least one entity is a single person, a group of people, a company, an ethnic group, a product or service, a group of products or services, or an audio visual production.

22. The method of claim 19, generating the at least one multimedia portfolio includes the submission of online forms by a user.

23. The method of claim 19, wherein the at least one multimedia portfolio is used as an advertising vehicle for commercial purposes.

24. The method of claim 19, wherein the at least one multimedia portfolio is configured to showcase in local or remote media platforms, including the local computer used by a user, the Internet, an Intranet, a social networking platform, online stores, a PDA, a portable music device, a cellular phone, a game console or TV networks.
